(19) United States
(12) Patent Application Publication
(10) Pub. No.: US 2024/0276986 A1
(43) Pub. Date: Aug. 22, 2024

(54) Compositions With Ethofumesate And A Safener

(71) Applicant: BAYER AKTIENGESELLSCHAFT, Leverkusen (DE)

(72) Inventors: Thomas AULER, Bergisch Gladbach (DE); Herve TOSSENS, Verlaine (BE); Robert CANALES, Lyon (FR); Mark BARTLETT, York (GB); Chris PARSONS, Hertfordshire (GB)

(21) Appl. No.: 18/565,656

(22) PCT Filed: May 31, 2022
(86) PCT No.: PCT/EP2022/064793

§ 371 Date: Nov. 30, 2023

(30) Foreign Application Priority Data
Jun. 2, 2021 (EP) 21177454.2

(51) Int. Cl. A01N 43/12; A01N 25/32; A01P 13/02

(52) U.S. Cl. CPC A01N 43/12; A01N 25/32; A01P 13/02

(57) ABSTRACT

The present invention primarily relates to (the use of) certain herbicidal compositions with (i) ethofumesate according to formula (I) and (ii) a safener in the protection of crop plants, in particular cereals such as wheat or barley. The present invention also relates to the use of said compositions in the field of agriculture and for controlling harmful plants. The present invention further relates to corresponding methods.

The present invention primarily relates to (the use of) certain herbicidal compositions with (i) ethofumesate according to formula (I) and (ii) a safener in the protection of crop plants, in particular cereals such as wheat or barley. The present invention also relates to the use of said compositions in the field of agriculture and for controlling harmful plants. The present invention further relates to corresponding methods.

Ethofumesate (IUPAC name 2-ethoxy-2,3-dihydro-3,3-dimethylbenzofuran-5-yl methanesulfonate)of the following formula (I), is a known benzofurane herbicide. It is used pre- and post-emergence for grass and broad-leaved weed control in various crops, in particular sugarbeet.

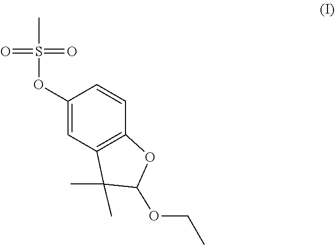 [SMILES: CCOC1Oc2ccc(OS(C)(=O)=O)cc2C1(C)C]

EP 0 113 169 A2 teaches herbicidal mixtures having synergistic activity based on the combination of (a) quizalafop, or a salt or ester thereof and (b) benazolin or a salt or ester thereof and/orethofumesate.

WO 2008/075065 A2 pertains to the protection of wheat crops by using compositions comprising ethofumesate as herbicide, wherein the composition is applied to the wheat crop either pre-emergence or post-emergence, in particular not before ZCK 13, and wherein the composition is applied to the wheat such that an amount of ethofumesate of between about 50 g/ha and about 800 g/ha is applied.

WO 2020/078874 A1 discloses herbicide combinations based on the combination of ethofumesate and bixlozone, optionally comprising a safener or further herbicides.

Weed Science 1975, Vol. 23, 409-413 inter alia observed that corn yields were reduced in proportion to the rate of ethofumesate applied 3 weeks before planting at rates of 2.2 to 9.0 kg/ha, and in greenhouse studies barley and wheat were about 10 times more susceptible to soil residues of ethofumesate than com.

Weed Science 1977, Vol. 25, 252-255 reports that ethofumesate applied pre-emergence or early post-emergence at 0.8 to 4.5 kg/ha eliminated annual bluegrass (Poa annua L.) in Italian ryegrass (Lolium multiflorum Lam.) seed fields.

Weed Science, 1980, Vol. 28, 292-294 evaluated in field experiments at rates from 0.6 to 4.5 kg/ha for control of volunteer wheat (Triticum aestivum L.) in fall-planted perennial ryegrass (Lolium perenne L.). Ethofumesate applied at 1.7 kg/ha or more to wheat in the one- to three-leaf stage eliminated the wheat. Wheat was not eliminated when ethofumesate was applied pre-emergence soon after planting or when applied at the end of November to wheat in the four-leaf to four-tiller stage.

Weed Science, 1981, Vol. 29, 712-717 reports on the effects of a pre-irrigation period on the pre-emergence activity of ethofumesate applied to dry soil, with subsequent irrigation and establishing stands of either sweet corn or winter wheat.

The herbicidal crop protection agents (herbicides) and compositions thereof known to date for controlling harmful plants or unwanted vegetation have some disadvantages, above all (a) that they have no or else insufficient herbicidal activity against specific harmful plants, (b) that the spectrum of harmful plants which can be controlled with the herbicides is not broad enough, (c) that the selectivity of herbicides in and the compatibility with crops is too low, thereby causing unwanted damage and/or unwanted reduced harvest yields of the crops, (d) that the initial herbicidal activity is not acceptable or not strong enough and/or (e) that the herbicidal activity does not last long enough. For this reason there is a constant need to develop novel herbicidal compositions which have advantages over the known ones at least in some areas.

Surprisingly, it has now been found that certain compositions with ethofumesate exhibit improved crop compatibility, i.e. low crop injury, in particular in cereals such as wheat or barley, especially cereal crops such as winter wheat and winter barley.

The present invention mainly is based on the observation that safeners can reduce the crop damage caused by ethofumesate to crop plants (crops), i.e. desired plants, in particular in monocotyledonous crop plants like cereals, in particular early post-emergence at growth stages before BBCH 13 of the crop plants, particularly in wheat crop plants and barley crop plants, especially in winter wheat crop plants and winter barley crop plants.

The use of a safener to reduce crop damage which may be caused by ethofumesate to crop plants has not been reported so far and is surprising because a safener typically exhibits its safening effects only for and in combination with specific herbicides or sometimes structurally similar herbicide classes.

For example, the safener mefenpyr-diethyl is effective in safening ALS-inhibitors like mesosulfuron and iodosulfuron, and esters and salts thereof.

The Weed Science Society of America (WSSA) publishes the “Herbicide Site of Action (SOA) Classification List” in which the various herbicides are grouped according to their Site of Action. These WSSA Groups are known to those skilled in the art. Herbicides from WSSA Group 15 are very long-chain fatty acid (VLCFA) synthesis inhibitor herbicides.

Ethofumesate however is not an ALS-inhibitor and does not have structural similarity to ALS-inhibitors, bit belongs to WSSA group 15. In own experiments it was found that the safener mefenpyr-diethyl does not have a safening effect—for example in cereral crops such as wheat or barley—when used with flufenacet, a herbicide which also belongs to WSSA group 15.

Furthermore, it has been found, that the compositions (used)according to the invention bring about the weed control activity of ethofumesate with respect to harmful plants (weeds) and at the same time not (substantially) damaging the crop plants. Thus, the compositions (used) according to the invention allow control of harmful plants that can be controlled by ethofumesate and achieve increased safety in use forth crop plants.

In a first aspect, the present invention therefore relates to a composition comprising
(i) ethofumesate of formula (I)

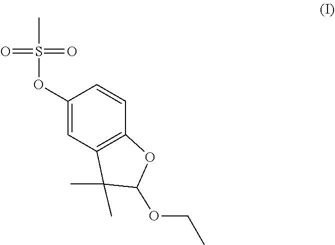 [SMILES: CCOC1Oc2ccc(OS(C)(=O)=O)cc2C1(C)C]

and
(ii) one or more safeners,
characterized in that constituents (i) and (ii) are present in a ratio in the range of from 6:1 to 1:4, based on the total weight of the composition, and wherein constituent (i) is the only herbicidally active ingredient.

Preferably, constituents (i) and (ii) are the only agrochemically active compounds present in said composition.

The compositions of the present invention are particularly suitable for the protection of cereral crop plant such as wheat crop plants and barley crop plants, in particular winter wheat crop plants and winter barley crop plants.

### Definition of Constituent (ii) Safener

S1) Compounds of the group of heterocyclic carboxylic acid derivatives:
S1^{a}) Compounds of the type of dichlorophenylpyrazoline-3-carboxylic acid (S1^{a}), preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr(-diethyl)”), and related compounds, as described in WO-A-91/07874;
S1^{b}) Derivatives of dichlorophenyl pyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds, as described in EP-A-333 131 and EP-A-269 806;
S1^{c}) Derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl l-(2-chlorophenyl)-5-phenylpyrazole-3-carboxylate (S1-6) and related compounds, as described, for example, in EP-A-268554;
S1^{d}) Compounds of the type of triazolecarboxylic acids (S1^{d}), preferably compounds such as fenchlorazole(-ethyl), i.e. ethyl 1-(2,4-dichlorophenyl)-5-trichloromethyl-(1H)-1,2,4-triazole-3-carboxylate (S1-7), and related compounds, as described in EP-A-174 562 and EP-A-346 620;
S1^{e}) Compounds of the type of 5-benzyl- or 5-phenyl-2-isoxazoline-3-carboxylic acid or 5,5-diphenyl-2-isoxazoline-3-carboxylic acid (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds, as described in WO-A-91/08202, or 5,5-diphenyl-2-isoxazolinecarboxylic acid (S1-10) or ethyl 5,5-diphenyl-2-isoxazolinecarboxylate (S1-11) (“isoxadifen-ethyl”) or n-propyl 5,5-diphenyl-2-isoxazolinecarboxylate (S1-12) or ethyl 5-(4-fluorophenyl)-5-phenyl-2-isoxazoline-3-carboxylate (S1-13), as described in the patent application WO-A-95/07897.
S2) Compounds of the group of 8-quinolinoxy derivatives (S2):
S2^{a}) Compounds of the type of 8-quinolinoxyacetic acid (S2^{a}), preferably 1-methylhexyl (5-chloro-8-quinolinoxy)acetate (common name “cloquintocet-mexyl” (S2-1), 1,3-dimethyl-but-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxo-prop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), its hydrates and salts, for example its lithium, sodium, potassium, calcium, magnesium, aluminium, iron, ammonium, quaternary ammonium, sulphonium or phosphonium salts, as described in WO-A-2002/34048;
S2^{b}) Compounds of the type of (5-chloro-8-quinolinoxy)malonic acid (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
S3) Active compounds of the type of dichloroacetamides (S3) which are frequently used as pre-emergence safeners (soil-acting safeners), such as, for example, “dichlormid” (N,N-diallyl-2,2-dichloroacetamide) (S3-1), “R-29148” (3-dichloroacetyl-2,2,5-trimethyl-1,3-oxazolidine) (S3-2), “R-28725” (3-dichloroacetyl-2,2-dimethyl-1,3-oxazolidine) (S3-3), “benoxacor” (4-dichloroacetyl-3,4-dihydro-3-methyl-2H-1,4-benzoxazine) (S3-4), “PPG-1292” (N-allyl-N-[(1,3-dioxolan-2-yl)methyl]dichloroacetamide) (S3 5), “DKA-24” (N-allyl-N-[(allylaminocarbonyl)methyl]dichloroacetamide) (S3-6), “AD-67” or “MON 4660” (3-dichloroacetyl-1-oxa-3-aza-spiro[4,5]decane) (S3-7), “TI-35” (1-dichloroacetylazepane) (S3-8) “diclonon” (dicyclonon) (S3-9) ((RS)-1-dichloroacetyl-3,3,8a-trimethylperhydropyrrolo[1,2-a]pyrimidin-6-one), furilazole” or “MON 13900” ((RS)-3-dichloroacetyl-5-(2-furyl)-2,2-dimethyloxazolidine) (S3-10), and also its (R)-isomer (S3-11).
S4) Compounds of the class of acylsulphonamides (S4):
S4^{a})N-acylsulphonamides of the formula (S4a) and salts thereof, as described in WO-A-97/45016

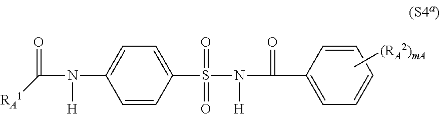

in which
R_{A}¹ is (C₁-C₆)-alkyl, (C₃-C₆)-cycloalkyl, where the 2 last-mentioned radicals are substituted by V_{A} substituents from the group consisting of halogen, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl;
R_{A}² is halogen, (C₁-C₄)-alkyl, (C₁-C₄)-alkoxy, CF₃;
mA is 1 or 2;
VD is 0, 1, 2 or 3;
S4^{b}) Compounds of the type of 4-(benzoylsulphamoyl)benzamides of the formula (S₄^{b}) and salts thereof, as described in WO-A-99/16744,

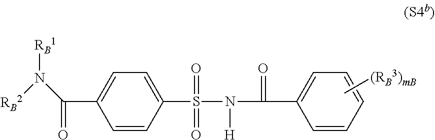

in which
   R_{B}¹, R_{B}² independently of one another are hydrogen, (C₁-C₆)-alkyl, (C₃-C₆)-cycloalkyl, (C₃-C₆)-alkenyl, (C₃-C₆)-alkynyl,
   R_{B}³ is halogen, (C₁-C₄)-alkyl, (C₁-C₄)-haloalkyl or (C₁-C₄)-alkoxy,
   m_{B} is 1 or 2;
   for example those in which
   R_{B}¹=cyclopropyl, R_{B}²=hydrogen and (R_{B}³)=2-OMe (“cyprosulfamide”, S4-1),
   R_{B}¹=cyclopropyl, R_{B}²=hydrogen and (R_{B}³)=5-Cl-2-OMe (S4-2),
   R_{B}¹=ethyl, R_{B}²=hydrogen and (R_{B}³)=2-OMe (S4-3),
   R_{B}¹=isopropyl, R_{B}²=hydrogen and (R_{B}³)=5-Cl-2-OMe (S4-4) and
   R_{B}¹=isopropyl, R_{B}²=hydrogen and (R_{B}³)=2-OMe (S4-5);
S4^{c}) Compounds of the class of benzoylsulphamoylphenylureas of the formula (S4^{c}) as described in EP-A-365484,

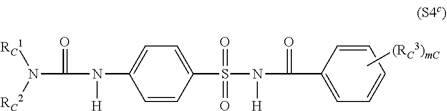

in which
   R_{c}¹, R_{c}² independently of one another are hydrogen, (C₁-C₈)-alkyl, (C₃-C₈)-cycloalkyl, (C₃-C₆)-alkenyl, (C₃-C₆)-alkynyl,
R_{c}³ is halogen, (C₁-C₄)-alkyl, (C₁-C₄)-alkoxy, CF₃,
mc is 1 or 2;
for example
1-[4-(N-2-methoxybenzoylsulphamoyl)phenyl]-3-methylurea,
   1-[4-(N-2-methoxybenzoylsulphamoyl)phenyl]-3,3-dimethylurea,
   1-[4-(N-4,5-dimethylbenzoylsulphamoyl)phenyl]-3-methylurea;
S4^{d}) Compounds of the type of N-phenylsulphonylterephthalamides of the formula (S4^{d}) and salts thereof, which are known, for example, from CN 101838227,

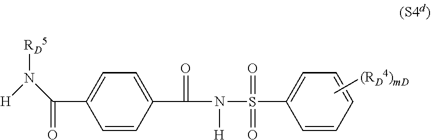

in which
R_{D}⁴ is halogen, (C₁-C₄)-alkyl, (C₁-C₄)-alkoxy, CF₃;
m_{D} is 1 or 2;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl.
S5) Active compounds from the class of hydroxyaromatics and aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994,WO-A-2005/016001.
S6) Active compounds from the class of 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulphonylaminoethyl)-3-(2-thienyl)-1,2-dihydroquinoxalin-2-one, as described in WO-A-2005/112630.
S7) Compounds from the class of diphenylmethoxyacetic acid derivatives (S7), for example methyl diphenylmethoxyacetate (CAS-Reg.Nr. 41858-19-9) (S7-1), ethyl diphenylmethoxyacetate, or diphenylmethoxyacetic acid, as described in WO-A-98/38856.
S8) Compounds of the formula (S8), as described in WO-A-98/27049,

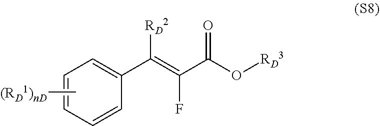

where the symbols and indices have the following meanings:
R_{D}¹ is halogen, (C₁-C₄)-alkyl, (C₁-C₄)-haloalkyl, (C₁-C₄)-alkoxy, (C₁-C₄)-haloalkoxy,
R_{D}² is hydrogen or (C₁-C₄)-alkyl,
R_{D}³ is hydrogen, (C₁-C₈)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof,
n_{D} is an integer from 0 to 2.
S9) Active compounds from the class of 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999/000020.
S10) Compounds of the formula (S10^{a}) or (S10^{b}) as described in WO-A-2007/023719 and WO-A-2007/023764

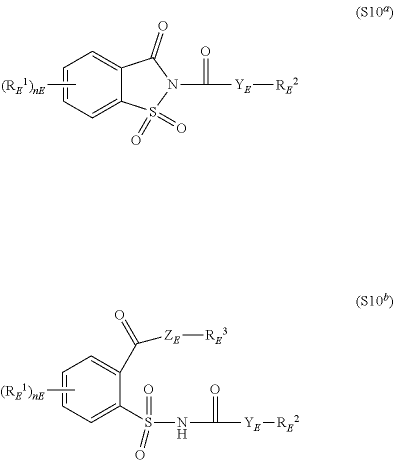

in which
R_{E}¹ is halogen, (C₁-C₄)-alkyl, methoxy, nitro, cyano, CF₃, OCF₃
Y_{E}, Z_{E} independently of one another are O or S,
n_{E} is an integer from 0 to 4,
R_{E}² is (C₁-C₆)-alkyl, (C₂-C₆)-alkenyl, (C₃-C₆)-cycloalkyl, aryl; benzyl, halobenzyl,
R_{E}³ is hydrogen or (C₁-C₆)-alkyl.
S11) Active compounds of the type of oxyimino compounds (S11), which are known as seed dressings, such as, for example, “oxabetrinil” ((Z)-1,3-dioxolan-2-ylmethoxyimino(phenyl)acetonitrile) (S11-1), which is known as seed dressing safener for millet against metolachlor damage,
   “fluxofenim” (1-(4-chlorophenyl)-2,2,2-trifluoro-1-ethanone O-(1,3-dioxolan-2-ylmethyl)oxime) (S11-2), which is known as seed dressing safener for millet against metolachlor damage, and
   “cyometrinil” or “CGA-43089” ((Z)-cyanomethoxyimino(phenyl)acetonitrile) (S11-3), which is known as seed dressing safener for millet against metolachlor damage.
S12) Active compounds from the class of isothiochromanones (S12), such as, for example, methyl[(3-oxo-1H-2-benzothiopyran-4(3H)-ylidene)methoxy]acetate (CAS Reg. No.: 205121-04-6)(S12-1) and related compounds from WO-A-1998/13361.
S13) One or more compounds from group (S13):
   “naphthalic anhydrid” (1,8-naphthalenedicarboxylic anhydride) (S13-1), which is known as seed dressing safener for corn against thiocarbamate herbicide damage,
   “fenclorim” (4,6-dichloro-2-phenylpyrimidine) (S13-2), which is known as safener for pretilachlor in sown rice,
   “flurazole” (benzyl 2-chloro-4-trifluoromethyl-1,3-thiazole-5-carboxylate) (S13-3), which is known as seed dressing safener for millet against alachlor and metolachlor damage,
   “CL 304415” (CAS Reg. No.: 31541-57-8) (4-carboxy-3,4-dihydro-2H-1-benzopyran-4-acetic acid) (S13-4) from American Cyanamid, which is known as safener for corn against imidazolinone damage,
   “MG 191” (CAS Reg. No.: 96420-72-3) (2-dichloromethyl-2-methyl-1,3-dioxolane) (S13-5) which is known as safener for corn,
   “MG838” (CAS Reg. No.: 133993-74-5) (2-propenyl 1-oxa-4-azaspiro[4.5]decane-4-carbodithioate) (S13-6),
   “disulphoton” (0,0-diethyl S-2-ethylthioethyl phosphorodithioate) (S13-7),
   “dietholate” (0,0-diethyl 0-phenyl phosphorothioate) (S13-8),
   “mephenate” (4-chlorophenyl methylcarbamate) (S13-9).
S14) Active compounds which, besides a herbicidal effect against harmful plants, also have a safener effect on crop plants such as rice, such as, for example, “dimepiperate” or “MY 93” (S-1-methyl-1-phenylethyl piperidine-1-carbothioate), which is known as safener for rice against molinate herbicide damage,
   “daimuron” or “SK 23” (1-(1-methyl-1-phenylethyl)-3-p-tolylurea), which is known as safener for rice against imazosulphuron herbicide damage,
   “cumyluron”=“JC 940” (3-(2-chlorophenylmethyl)-1-(1-methyl-1-phenylethyl)urea, see JP-A-60087254), which is known as safener for rice against some herbicide damage,
   “methoxyphenone” or “NK 049” (3,3′-dimethyl-4-methoxybenzophenone), which is known as safener for rice against some herbicide damage,
   “CSB” (1-bromo-4-(chloromethylsulphonyl)benzene) from Kumiai (CAS Reg. No. 54091-06-4), which is known as safener against some herbicide damage in rice.
S15) Compounds of the formula (S15) or its tautomers,

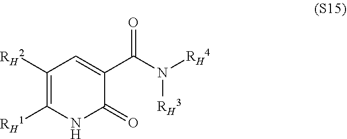

as described in WO-A-2008/131861 and WO-A-2008/131860,
in which
R_{H}¹ is (C₁-C₆)-haloalkyl,
R_{H}² is hydrogen or halogen,
R_{H}³, R_{H}⁴ independently of one another are hydrogen, (C₁-C₁₆)-alkyl, (C₂-C₁₆)-alkenyl or (C₂-C₁₆)-alkynyl,
   where each of the 3 last-mentioned radicals is unsubstituted or substituted by one or more radicals from the group consisting of halogen, hydroxy, cyano, (C₁-C₄)-alkoxy, (C₁-C₄)-haloalkoxy, (C₁-C₄)-alkylthio, (C₁-C₄)-alkylamino, di-[(C₁-C₄)-alkyl]-amino, [(C₁-C₄)-alkoxy]-carbonyl, [(C₁-C₄)-haloalkoxy]-carbonyl, unsubstituted or substituted (C₃-C₆)-cycloalkyl, unsubstituted or substituted phenyl, and unsubstituted or substituted heterocyclyl;
   or (C₃-C₆)-cycloalkyl, (C₄-C₆)-cycloalkenyl, (C₃-C₆)-cycloalkyl which is at one site of the ring condensed with a 4 to 6-membered saturated or unsaturated carbocyclic ring, or (C₄-C₆)-cycloalkenyl which is at one site of the ring condensed with a 4 to 6-membered saturated or unsaturated carbocyclic ring,
   where each of the 4 last-mentioned radicals is unsubstituted or substituted by one or more radicals from the group consisting of halogen, hydroxy, cyano, (C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-alkylamino, di-(C₁-C₄)-alkyl]-amino, [(C₁-C₄)-alkoxy]-carbonyl, [(C₁-C₄)-haloalkoxy]-carbonyl, unsubstituted or substituted (C₃-C₆)-cycloalkyl, unsubstituted or substituted phenyl, and unsubstituted or substituted heterocyclyl; or
R_{H}³ is (C₁-C₄)-alkoxy, (C₂-C₄)-alkenyloxy, (C₂-C₆)-alkynyloxy or (C₂-C₄)-haloalkoxy, and
R_{H}⁴ is hydrogen or (C₁-C₄)-alkyl, or
R_{H}³ and R_{H}⁴ together with the directly bound N-atom are a 4 to 8-membered heterocyclic ring, which can contain further hetero ring atoms besides the N-atom, preferably up to two further hetero ring atoms from the group consisting of N, O and S, and which is unsubstituted or substituted by one or more radicals from the group consisting of halogen, cyano, nitro, (C₁-C₄)-alkyl, (C₁-C₄)-haloalkyl, (C₁-C₄)-alkoxy, (C₁-C₄)-haloalkoxy, and (C₁-C₄)-alkylthio.
   Agrochemically Active Compounds The agrochemically active compounds used in the context of the present invention are known per se, and described inter alia in “The Pesticide Manual”, 16^{th} edition, The British Crop Protection Council and the Royal Soc. of Chemistry, 2012 and the literature cited therein.

Preferred is a composition (used) according to the invention wherein fenchlorazole-ethyl (S1), mefenpyr-diethyl (S2), isoxadifen-ethyl (S3), cyprosulfamide (S4), cloquintocet-mexyl (S5), fenclorim (S6), dichlormid (S7), benoxacor (S8), furilazole (S9), oxabetrinil (S10), fluxofenim (S11), flurazole (S12) or naphthalic anhydride (S13) is the safener.

More preferred is a composition (used) according to the invention wherein mefenpyr-diethyl (S2), isoxadifen-ethyl (S3), cyprosulfamide (S4) or cloquintocet-mexyl (S5) is the safener.

Most preferred is a composition (used) according to the invention wherein mefenpyr-diethyl (S2) or cloquintocet-mexyl (S5) is the safener.

A further most preferred aspect according to the invention is a composition comprising(i)ethofumesate of formula (I), (ii) mefenpyr-diethyl as safener.

The weight ratio of the composition (used) according to the invention can be described by the weight of the total amount of constituent (i) to the total amount of constituent (ii) and is in the range of from 6:1 to 1:4, typically said ratio is in the range of from 4:1 to 1:2.

Preferably, the ratio by weight of the total amount of constituent (i) to the total amount of constituent (ii) in compositions (used) according to the present invention is in the range of from 3:1 to 1:2, typically said preferred ratio is in the range of from 3:1 to 2:3.

More preferably, the ratio by weight of the total amount of constituent (i)to the total amount of constituent (ii) in compositions (used) according to the present invention is in the range of from 5:2 to 2:3, typically said more preferred ratio is in the range of from 5:2 to 1:1.

The ratio by weight of the total amount of constituent (i) to the total amount of constituent (ii) in compositions (used) according to the present invention may also be in the range of from 2:1 to 1:2, in such a case typically said ratio is in the range of from 2:1 to 1:1.

Most preferably, the ratio by weight of the total amount of constituent (i)to the total amount of constituent (ii) in compositions (used) according to the present invention is about 1:1 or exactly 1:1, or the most preferred ratio by weight of the total amount of constituent (i) to the total amount of constituent (ii) in compositions (used) according to the present invention is about 2:1 or exactly 2:1, or the most preferred ratio by weight of the total amount of constituent (i) to the total amount of constituent (ii)in compositions (used) according to the present invention is about 3:2 or exactly 3:2, or the most preferred ratio by weight of the total amount of constituent (i) to the total amount of constituent (ii) in compositions (used) according to the present invention is about 5:2 or exactly 5:2.

Own experiments have shown that a ratio by weight of the total amount of constituent (i) to the total amount of constituent (ii) in compositions (used) according to the present invention of about 3:2 or exactly 3:2 is particularly advantageous in the context of the present invention.

Also, own experiments have shown that a ratio by weight of the total amount of constituent (i)to the total amount of constituent (ii) in compositions (used) according to the present invention of about 5:2 or exactly 5:2 is particularly advantageous in the context of the present invention.

The properties and advantages mentioned are of use for controlling harmful plants or unwanted vegetation and accordingly to safeguard and/or to increase the yields in terms of quality and quantity. The technical standard is, with regard to the properties described, clearly exceeded by these new combinations.

The compositions (used) according to the present invention can be employed for controlling harmful plants in genetically modified wheat crops or wheat crops obtained by mutation/selection. These crops are distinguished as a rule by particular, advantageous properties, such as resistances to herbicidal combinations/compositions or resistances to plant diseases or causative agents of plant diseases such as particular insects or microorganisms such as fungi, bacteria or viruses. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

The present invention also relates to a method for controlling harmful plants or unwanted vegetation, which comprises applying a composition (used) according to the present invention by pre-emergence, early post-emergence or post-emergence treatment to harmful plants or unwanted vegetation, parts of said harmful plants or unwanted vegetation, or the area where the harmful plants or unwanted vegetation grow, for example the area under cultivation. Also, the compositions of the present invention are useful for seed treatment, in particular for seed treatment of seeds of cereals such as wheat, barley, rye, oats and millet, especially wheat and barley, particularly winter wheat and winter barley.

In the context of the present invention “controlling” denotes a significant reduction of the growth of the harmful plant(s) in comparison to the untreated harmful plants. Preferably, the growth of the harmful plant(s) is essentially diminished (60-79%), more preferably the growth of the harmful plant(s) is largely or fully suppressed (80-100%), and in particular the growth of the harmful plant(s) is almost fully or fully suppressed (90-100%).

If a composition (used) according to the present invention is applied to the soil surface before or after germination of the plant but prior to emergence from the soil, the treatment is a pre-emergence treatment.

If a composition (used) according to the present invention is applied to the soil surface after emergence of the plant, the treatment is a post-emergence treatment.

Preferred in the context of the present invention is the use of compositions as defined herein in wheat crop plants, preferably selected from the group consisting of Triticum durum and Triticum aestivum, especially winter wheat such as soft winter wheat (TRZAW). Also preferred in the context of the present invention is the use of compositions as defined herein in barley (Hordeum vulgare) crop plants, preferably in winter barley (HORVW).

The application rates (indicated as g/ha, i.e. grams of active ingredient per hectare), of constituent (i), constituent (ii), as defined in the context of the present invention, are as follows:

| | (i) in g/ha | (ii) in g/ha |
|---|---|---|
| | 700 to 50 | 700 to 50 |
| Preferred | 600 to 50 | 600 to 50 |
| More preferred | 500 to 100 | 500 to 50 |
| Most preferred | 300 to 100 | 300 to 50 |

Particularly preferred in the context of the present invention are compositions, uses and methods as described herein wherein the application rate of constituent (i) ethofumesate is 300 to 100 g/ha and wherein the application rate of constituent (ii) safener, preferably mefenpyr-diethyl, is 100 to 50 g/ha.

The compositions (used) according to the present invention have an outstanding herbicidal activity against a broad spectrum of economically important harmful monocotyledonous and dicotyledonous harmful plants occurring in wheat crops and fields where wheat crop plants are growing or intended to grow.

In the context of the present text, reference is made to the BBCH-scale (particularly for cereals) and the BBCH growth stages describing the phenological development of (cereal) crop plants using the BBCH-scale according to the BBCH monograph “Growth stages of mono- and dicotyledonous plants”, 2nd edition, 2001, ed. Uwe Meier, Federal Biological Research Centre for Agriculture and Forestry (Biologische Bundesanstaltfür Land und Forstwirtschaft).

The following BBCH cereal growth stages are of particular relevance in the context of the present invention:

| BBCH | Growth stage | Description |
|---|---|---|
| 00 | Germination | Dry seed (caryopsis) |
| 01 | Germination | Beginning of seed imbibition |
| 03 | Germination | Seed imbibition complete |
| 05 | Germination | Radicle emerged from caryopsis |
| 06 | Germination | Radicle elongated, root hairs and/or side |
| | | roots visible |
| 07 | Germination | Coleoptile emerged from caryopsis |
| 09 | Germination | Coleoptile penetrates soil surface |
| | | (cracking stage) |
| 10 | Leaf development | First leaf through coleoptile |
| 11 | Leaf development | First leaf unfolded |
| 12 | Leaf development | Two leaves unfolded |
| 13 | Leaf development | Three leaves unfolded |

In the context of the present invention cereal crops are of particular interest, such as wheat, barley, rye, oats and millet, particularly wheat and barley, especially winter wheat and winter barley.

Specifically, examples may be mentioned of some representatives of the monocotyledonous and dicotyledonous weed flora which can be controlled by the compositions (used) according to the present invention, without the enumeration being a restriction to certain species.

Examples of monocotyledonous harmful plants on which the compositions (used) according to the present invention act efficiently are from amongst the genera Hordeum spp., Echinochloa spp., Poa spp., Bromus spp., Digitaria spp., Eriochloa spp., Setaria spp., Pennisetum spp., Eleusine spp., Eragrostis spp., Panicum spp., Lolium spp., Alopecurus sp., Apera sp. Brachiaria spp., Leptochloa spp., Avena spp., Cyperus spp., Axonopris spp., Sorghum spp., Phalaris sp., and Melinus spp.

Particular examples of monocotyledonous harmful plants species on which the compositions (used) according to the present invention act efficiently are selected from amongst the species Hordeum murnuam, Echinochloa crus-galli, Poa annaa, Bromas rubens L., Bromas rigidas, Bromas secalinas L., Digitaria insularis, Digitaria sanguinalis, Eriochloa gracilis, Setaria faberi, Setaria viridis, Pennisetum glaucum, Eleusine indica, Eragrostispectinacea, Panicummiliaceum, Lolium sp., Brachiaria platyphylla, Leptochloa fusca, Avena fatua, Cyperus compressus, Cyperus esculentes, Axonopris offinis, Sorghum halapense, Alopecurus myosuroides, Apera spica-venti, and Melinus repens.

Specific examples of monocotyledonous harmful plants species particularly relevant in cereal (in particular wheat) crops on which the compositions (used) according to the present invention act efficiently are Poa annua, Bromus rubens L., Bromus rigidus, Bromus secalinus L., Lolium sp., Avena fatua, Alopecurus myosuroides, Apera spica-venti, and Phalaris minor.

Examples of dicotyledonous harmful plants on which the compositions (used) according to the present invention act efficiently are from amongst the genera Amaranthus spp., Polygonum spp., Medicago spp., Mollugo spp., Cyclospermum spp., Stellaria spp., Gnaphalium spp., Taraxacum spp., Oenothera spp., Amsinckia spp., Erodium spp., Erigeron spp., Senecio spp., Lamium spp., Kochia spp., Chenopodium spp., Lactuca spp., Malva spp., Ipomoea spp., Brassica spp., Sinapis spp., Urtica spp., Sida spp, Portulaca spp., Richardia spp., Ambrosia spp., Calandrinia spp., Sisymbrium spp., Sesbania spp., Capsella spp., Sonchus spp., Euphorbia spp., Helianthus spp., Coronopus spp., Salsola spp., Abutilon spp., Vicia spp., Epilobium spp., Cardamine spp., Picris spp., Trifolium spp., Galinsoga spp., Epimedium spp., Marchantia spp., Solanum spp., Oxalis spp., Metricaria spp., Plantago spp., Tribulus spp., Cenchrus spp. Bidens spp., Veronica spp., and Hypochaeris spp.

Particular examples of dicotyledonous harmful plants species on which the compositions (used)according to the present invention act efficiently are selected from amongst the species Amaranthus spinosus, Amaranthus palmer, Amaranthis rudis, Polygonum convolvulus, Medicago polymorpha, Mollugo verticillata, Cyclospermum leptophyllum, Stellaria media, Gnaphalium purpureum, Taraxacum officinale, Oenothera laciniata, Amsinckia intermedia, Erodium cicutarium, Erodium moschatum, Erigeron bonariensis, Senecio vulgaris, Lamium sp., Erigeron canadensis, Polygonumaviculare, Kochiascoparia, Chenopodium album, Lactuca serriola, Malva parviflora, Malva neglecta, Ipomoea hederacea, Ipomoea lacunose, Brassica nigra, Sinapis arvensis, Urtica dioica, Amaranthus blitoides,Amaranthusretroflexus, Amaranthus hybridus, Amaranthus lividus, Sida spinosa, Portulaca oleracea, Richardia scabra, Ambrosia artemisiifolia, Calandrinia caulescens, Sisymbrium irio, Sesbania exaltata, Capsella bursa-pastoris, Sonchus oleraceus, Euphorbia maculate, Helianthus annuus, Coronopus didymus, Salsola tragus, Abutilon theophrasti, Vicia benghalensis L., Epilobium paniculatum, Cardamine spp, Picris echioides, Trifolium spp., Galinsoga spp., Epimedium spp., Marchantia spp., Solanum spp., Oxalis spp., Matricaria chamomilla, Plantago spp., Tribulus terrestris, Salsola kali, Cenchrus spp., Bidens bipinnata, Veronica sp., Galium aparine L., Papaver rhoeas, Viola arvense, Centaurea cyanus and Hypochaeris radicata.

Particular examples of dicotyledonous harmful plants species particularly relevant in cereal (in particular wheat) crops on which the compositions (used) according to the present invention act efficiently are Stellaria media, Senecio vulgaris, Lamium sp., Polygonum aviculare, Kochia scoparia, Chenopodium album, Brassica nigra, Sinapis arvensis, Capsella bursa-pastoris, Sonchus oleraceus, Matricaria chamomilla, Veronica sp., Galium aparine L., Papaver rhoeas, Viola arvense, and Centaurea cyanus.

The compositions (used) according to the present invention are easily and readily obtained, by combining the constituents (i) and (ii), in the amounts and ratios by weight as defined in the context of the present invention, for example by mixing the appropriate amounts of constituent (i) and (ii).

Thus, in a further aspect, the present invention relates to a method for producing the compositions (used) according to the present invention comprising the steps of
(a) providing constituent (i),
(b) providing constituent (ii),
(c) combining constituent (i) and constituent (ii), such that a composition (used) according to the present invention is obtained.

The constituents (i) and (ii), present in the compositions (used) in accordance with the present invention may be applied once, twice or three times per Gregorian calendar year, i.e. in one application, in two applications or in three applications per year according to the Gregorian calendar.

The compositions (used) according to the invention may additionally comprise one or more further components selected from the group consisting of formulation auxiliaries and formulation additives customary in crop protection.

Furthermore, the constituents (i) and (ii), as defined herein can be used together with formulation auxiliaries and formulation additives customary in crop protection. Additives are, for example, fertilizers and colorants.

The compositions (used) in accordance with the present invention cannot only be used as mixed formulations which are then applied in the customary manner as a dilution with water, but also as so-called tank mixes by jointly diluting the separately formulated, or partially separately formulated, components with water, thereby resulting in a ready-to-use application spray mixture.

Such a tank mix can for example be obtained by combining a formulation of (i)ethofumesate, for example comprising a total amount of (i) ethofumesate in the range of from 100 g/L to 600 g/L, such as a commercially available SC formulation containing 500 g/L of ethofumesate, and a formulation of (ii) safener(s), for example comprising a total amount of (ii) safener(s) in the range of from 50 g/L to 600 g/L, and diluting same with the appropriate amount of water to obtain a ready-to-use application spray mixture. The compositions (used) in accordance with the present invention can be formulated in various ways, depending on the prevailing biological and/or chemical-physical parameters. The following are examples of general possibilities for formulations: wettable powders (WP), water-soluble concentrates, emulsifiable concentrates (EC), aqueous solutions (SL), emulsions (EW) such as oil-in-water and water-in-oil emulsions, sprayable solutions or emulsions, suspension concentrates (SC), oil dispersions (OD), oil- or water-based dispersions, suspoemulsions, dusts (DP), seed-dressing materials, granules for soil application or for broadcasting, or water-dispersible granules (WG), ULV formulations, microcapsules (e.g. CS, ZC) or waxes.

The individual formulation types are known in principle and are described for example, in: Winnacker-Küchler, “Chemische Technologie”, Volume 7, C. Hauser Verlag Munich, 4^{th} Edition, 1986; van Valkenburg, “Pesticide Formulations”, Marcel Dekker N.Y., 1973; K. Martens, “Spray Drying Handbook”, 3rd Ed. 1979, G. Goodwin Ltd. London.

The formulation auxiliaries required, such as inert materials, surfactants, solvents and other additives are also known and are described, for example, in Watkins, “Handbook of Insecticide Dust Diluents and Carriers”, 2nd Ed., Darland Books, Caldwell N.J.; H.v. Olphen, “Introduction to Clay Colloid Chemistry”; 2nd Ed., J. Wiley & Sons, N.Y. Marsden, “Solvents Guide”, 2nd Ed., Interscience, N.Y. 1950; McCutcheon's, “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schönfeldt, “Grenzflächenaktive Äthylenoxidaddukte” [Surface-active ethylene oxide adducts], Wiss. Verlagsgesellschaft, Stuttgart 1976, Winnacker-Küchler, “Chemische Technologie”, Volume 7, C. Hauser Verlag Munich, 4^{th} Edition 1986.

Wettable powders (sprayable powders) are products which are uniformly dispersible in water and which, besides the active compound, also comprise ionic or nonionic surfactants (wetters, dispersants), for example polyoxethylated alkylphenols, polyethoxylated fatty alcohols or fatty amines, alkanesuffonates or alkylbenzenesulfonates, sodium lignosulfonate, sodium 2,2′-dinaphthylmethane-6,6′-disulfonate, sodium dibutylnaphthalenesulfonate or else sodium oleoylmethyltauride, in addition to a diluent or inert material

Emulsifiable concentrates are prepared by dissolving the active compound in an organic solvent, for example butanol, cyclohexanone, dimethylformamide, xylene or else higher-boiling aromatics or hydrocarbons with addition of one or more ionic or nonionic surfactants (emulsifiers). Examples of emulsifiers which may be used are: calcium salts of alkylarylsulfonic acids, such as calcium dodecylbenzene sulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxethylene sorbitol esters.

Dusts are obtained by grinding the active compound with finely divided solid materials, for example talc, natural clays such as kaolin, bentonite and pyrophyllite, or diatomaceous earth.

Suspension concentrates (SC) can be water- or oil-based. They can be prepared, for example, by wet grinding by means of commercially available bead mills and, if appropriate, addition of further surfactants as they have already been mentioned for example above in the case of the other formulation types.

Emulsions, for example oil-in-water emulsions (EW), can be prepared for example by means of stirrers, colloid mills and/or static mixers using aqueous organic solvents and, if appropriate, further surfactants as have already been mentioned for example above in the case of the other formulation types.

Granules can be prepared either by spraying the active compound onto adsorptive, granulated inert material or by applying active compound concentrates to the surface of carriers such as sand, kaolinites or granulated inert material with the aid of binders, for example polyvinyl alcohol, sodium polyacrylate or else mineral oils. Suitable active compounds may also be granulated in the manner conventionally used for the production of fertilizer granules, if desired in a mixture with fertilizers. As a rule, water-dispersible granules are prepared by customary processes such as spray drying, fluidized-bed granulation, disk granulation, mixing with high-speed mixers and extrusion without solid inert material. Regarding the production of disk granules, fluidized-bed granules, extruder granules and spray granules, see, for example, the methods in “Spray-Drying Handbook” 3rd ed. 1979, G. Goodwin Ltd., London; J. E. Browning, “Agglomeration”, Chemical and Engineering 1967, page 147 et seq; “Perry's Chemical Engineer's Handbook”, 5th Ed., McGraw-Hill, New York 1973, pp. 8-57.

As regards further details on the formulation of crop protection products, see, for example, G. C. Klingmam, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

As a rule, the agrochemical formulations comprise 1 to 95% by weight, of active compounds, the following concentrations being customary, depending on the type of formulation:

The active compound concentration in wettable powders is, for example, approximately 10 to 95% by weight, the remainder to 100% by weight being composed of customary formulation constituents. In the case of emulsifiable concentrates, the active compound concentration may amount to, for example, 5 to 80% by weight. Formulations in the form of dusts comprise, in most cases, 5 to 20% by weight of active compound, sprayable solutions approximately 0.2 to 25% by weight of active compound. In the case of granules such as dispersible granules, the active compound content depends partly on whether the active compound is present in liquid or solid form and on which granulation auxiliaries and fillers are being used. As a rule, the content amounts to between 10 and 90% by weight in the case of the water-dispersible granules.

In addition, the abovementioned active compound formulations may comprise, if appropriate, the conventional adhesives, wetters, dispersants, emulsifiers, preservatives, antifreeze agents, solvents, fillers, colorants, carriers, antifoams, evaporation inhibitors, pH regulators or viscosity regulators.

The herbicidal action of the herbicide(s) present in compositions (used) according to the present invention can be improved, for example, by surfactants, preferably by wetters from the group of the fatty alcohol polyglycol ethers. The fatty alcohol polyglycol ethers preferable contain 10-18 carbon atoms in the fatty alcohol radical and 2-20 ethylene oxide units in the polyglycol ether moiety. The fatty alcohol polyglycol ethers can be nonionic or ionic, for example in the form of fatty alcohol polyglycol ethers sulfates, which can be used, for example, as alkali metal salts (e.g. sodium salts or potassium salts) or ammonium salts, but also as alkaline earth metal salts such as magnesium salts, such as sodium C₁/C₁₄-fatty alcohol diglycol ether sulfate (Genapol® LRO, Clariant); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)-, preferably (C₁₀-C₁₄)-fatty alkohol polyglycol ethers containing 2-20, preferably 3-15, ethylene oxide units (e.g. isotridecyl alcohol polyglycol ether), for example from the Genapol® series, such as Genapol® X-030, Genapol® X-060, Genapol® X-080 or Genapol® X-150 (all from Clariant GmbH).

The present invention furthermore embraces (the use of) combinations of constituents (i) and (ii) as defined above with the wetting agents mentioned above from the group of the fatty alcohol polyglycol ethers which preferably contain 10-18 carbon atoms in the fatty alcohol radical and 2-20 ethylene oxide units in the polyglycol ether moiety and which can be present in nonionic or ionic form (for example as fatty alcohol polyglycol ether sulfates). Preference is given to C₁/C₁₄-fatty alcohol diglycol ether sulfate sodium (Genapol® LRO, Clariant); and isotridecyl alcohol polyglycol ether with 3-15 ethylene oxide units, for example from the Genapol® X series, such as Genapol® X-030, Genapol® X-060, Genapol® X-080 or Genapol® X-150 (all from Clariant GmbH). It is furthermore known that fatty alcohol polyglycol ethers such as nonionic or ionic fatty alcohol polyglycol ethers (for example fatty alcohol poly glycol ether sulfates) are also suitable for use as penetrants and activity enhancers for a number of other herbicides, inter alia also for herbicides from the group of the imidazolinones (see, for example, EP-A-0502014).

Moreover, it is known that fatty alcohol polyglycol ethers such as nonionic or ionic fatty alcohol polyglycol ethers (for example fatty alcohol polyglycol ether sulfates) are also suitable as penetrants and synergists for a number of other herbicides, inter alia also herbicides from the group of the imidazolinones; (see, for example, EP-A-0502014).

The herbicidal effect of the compositions (used) according to the present invention can also be increased using vegetable oils. The term vegetable oils is to be understood as meaning oils from oil-plant species, such as soya oil, rapeseed oil, corn oil, sunflower oil, cottonseed oil, linseed oil, coconut oil, palm oil, safflower oil or castor oil, in particular rapeseed oil, and their transesterification products, for example alkyl esters, such as rapeseed oil methyl ester or rapeseed oil ethyl ester.

The vegetable oils are preferably esters of C₁₀-C₂₂-, preferably C₁₂-C₂₀-fatty acids. The C₁₀-C₂₂-fatty acid esters are, for example, esters of unsaturated or saturated C₁₀-C₂₂-fatty acids, in particular those with an even number of carbon atoms, for example erucic acid, lauric acid, palmitic acid and, in particular, Cis-fatty acids such as stearic acid, oleic acid, linoleic acid or linolenic acid.

Preferred C₁-C₂₀-alkyl-C₁₀-C₂₂-fatty acid esters are the methyl, ethyl, propyl, butyl, 2-ethylhexyl and dodecyl esters. Preferred glycol- and glycerol-C₁₀-C₂₂-fatty acid esters are the uniform or mixed glycol esters and glycerol esters of C₁₀-C₂₂-fatty acids, in particular those fatty acids which have an even number of carbon atoms, for example erucic acid, lauric acid, palmitic acid and, in particular, Cis-fatty acids such as stearic acid, oleic acid, linolic acid or linolenic acid.

The vegetable oils can be present in the herbicidal compositions (used) according to the present invention for example in the form of commercially available oil-containing formulation additives, in particular those based on rapeseed oil such as Hasten® (Victorian Chemical Company, Australia, hereinbelow termed Hasten, main constituent: rapeseed oil ethyl ester), Actirob©B (Novance, France, hereinbelow termed ActirobB, main constituent: rapeseed oil methyl ester), Rako-Binol® (Bayer AG, Germany, termed Rako-Binol hereinbelow, main constituent: rapeseed oil), Renol® (Stefes, Germany, termed Renolhereinbelow, vegetable oil constituent: rapeseed oil methyl ester), or Stefes Mero® (Stefes, Germany, main constituent: rapeseed oil methyl ester).

For use, formulations comprising constituents (i) and (ii) present in the compositions (used) in accordance with the present invention are optionally diluted in the customary manner, for example using water in the case of wettable powders, emulsifiable concentrates, dispersions and water-dispersible granules. Preparations in the form of dusts, soil granules, granules for broadcasting and sprayable solutions are usually not diluted further with other inert substances prior to use.

The compositions as defined in the context of the present invention are preferably applied to the harmful plants or undesired plants or parts thereof, seeds of the plants or the area under cultivation (soil of a field), preferably to the green of the harmful plants or parts thereof, or to the green parts of the undesired plants or parts thereof.

A composition (used) in accordance with the present invention comprising constituents (i) and (ii) has the advantage of being easier to apply since the quantities of the components are already presented in the correct ratio to each other. Moreover, the adjuvants in the formulation can be matched optimally to each other.

As already described in more detail above, the present invention further relates to (the use of) compositions comprising constituents (i) and (ii) according to the present invention (preferably in one of the preferred embodiments, more preferred embodiments or particularly preferred embodiments defined herein) in the field of agriculture, in particular for controlling harmful plants or undesired plant growth.

In a further aspect of the present invention therefore relates to the use of a composition according to the present invention for the protection of crop plants, preferably of cereal crop plants, in particular of wheat crop plants or barley crop plants.

Said us is preferably characterized in that said composition is applied post emergence to the cereal crop plants, in particular to wheat crop plants or barley crop plants.

The present invention also relates to a method for controlling undesired vegetation characterized in that a composition as defined in the context of the present invention is applied to the undesired vegetation or to the area on which the crop plants are growing or will be growing.

Said method is preferably characterized in that the composition as defined in in the context of the present invention is applied post emergence to the crop plants, preferably post emergence to cereal crop plants.

Said uses or methods are preferably characterized in that a composition as defined in the context of the present invention is applied such that the amount of ethofumesate is in the range of from 700 g/ha to 50 g/ha, preferably in the range of from 600 g/ha to 50 g/ha, more preferably in the range of from 500 g/ha to 100 g/ha, most preferably in the range of from 300 g/ha to 100 g/ha.

Said uses or methods are preferably characterized in that said composition is applied to the cereal crop plants post emergence before BBCH growth stage 13, preferably at BBCH growth stages 09, 10,11 and/or 12, of the cereal crop plants, more preferably at BBCH growth stages 10, 11 and/or 12 of the cereal crop plants, particularly atBBCH growth stage 10, 11 or 12 of the cereal crop plants.

Said uses or methods are preferably characterized in that the (cereal) crop plants are wheat crop plants or barley crop plants.

Said uses or methods are preferably characterized in that the cereal crop plants are selected from the group consisting of Triticum durum, Triticum aestivum and Hordeum vulgare.

In a further aspect, the present invention relates to the use of mefenpyr-diethyl or cloquintocet-mexyl as safener for ethofumesate (preferably in cereal crop plants, in particular in wheat crop plants or barley crop plants).

### EXAMPLES

In field trials the interaction of (i) ethofumesate and (ii) the safener mefenpyr-diethyl concerning cereal crop injury was investigated.

Plots of different verities of wheat and barley crops in the field were sprayed with an application volume of 140 L/ha with a handheld spray boom.

Application of the application spray compostions was carried out early in each case post-emergence at BBCH growth stage 11 (first leaf unfolded) of the respective wheat or barley crops.

The four different soft winter wheat (TRZAW) varieties tested were ARTHUR NICK, ELIXER, PISTOLO and RUBISKO.

The three different winter barley (HORVW) varieties tested were CALIFORNIA, CIERZO and KWS ORBIT.

The maximum crop damage and the final crop damage were in each case visually rated on a percentage scale in relation to the untreated control (100%=all plants dead, complete crop kill; 50%=green plant biomass reduced by 50%, and 0%=like control plot, no crop injury).

The main symptoms of crop damage observed were thinning and stunting.

Results for soft winter wheat - Maximum crop damage in %

| | | Variety | | | |
|---|---|---|---|---|---|
| | Dose rate | ARTUR | Variety | Variety | Variety |
| | in g/ha | NICK | ELIXER | PISTOLO | RUBISKO |
| Ethofumesate | 250 | 16% | 63% | 24% | 30% |
| Ethofumesate + | 250 + 100 | 0% | 0% | 3% | 0% |
| Mefenpyr- | | | | | |
| diethyl | | | | | |

Results for soft winter wheat - Final crop damage in %

| | | Variety | | | |
|---|---|---|---|---|---|
| | Dose rate | ARTUR | Variety | Variety | Variety |
| | in g/ha | NICK | ELIXER | PISTOLO | RUBISKO |
| Ethofumesate | 250 | 11.6% | 28.3% | 14.0% | 13.7% |
| Ethofumesate + | 250 + 100 | 0.0% | 0.0% | 2.3% | 0.0% |
| Mefenpyr- | | | | | |
| diethyl | | | | | |

Results for winter barley - Maximum crop damage in %

| | Dose rate | Variety | Variety | Variety |
|---|---|---|---|---|
| | in g/ha | CALIFORNIA | CIERZO | KWS ORBIT |
| Ethofumesate | 250 | 25% | 28% | 45% |
| Ethofumesate + | 250 + 100 | 0% | 6% | 0% |
| Mefenpyr- | | | | |
| diethyl | | | | |

Results for winter barley - Final crop damage in %

| | Dose rate | Variety | Variety | Variety |
|---|---|---|---|---|
| | in g/ha | CALIFORNIA | CIERZO | KWS ORBIT |
| Ethofumesate | 250 | 12.5% | 19.7% | 25.0% |
| Ethofumesate + | 250 + 100 | 0.0% | 2.8% | 0.0% |
| Mefenpyr- | | | | |
| diethyl | | | | |

What is claimed is:

1. A herbicidal composition comprising
(i) ethofumesate,
and
(ii) one or more safeners,
characterized in that constituents (i) and (ii) are present in a ratio in the range of from 6:1 to 1:4, based on the total weight of the composition, and wherein constituent (i) is the only herbicidally active ingredient.

2. The composition according to claim 1 characterized in that constituent (ii) comprises or consists of mefenpyr-diethyl or cloquintocet-mexyl.

3. The composition according to claim 1 characterized in that constituents (i) and (ii) are the only agrochemically active compounds present in said composition.

4. The composition according to claim 1 characterized in that the ratio by weight of the total amount of constituent (i) to the total amount of constituent (ii) is in the range of from 4:1 to 1:2, based on the total amount of the composition.

5. The composition according to claim 1 characterized in that the ratio by weight of the total amount of constituent (i) to the total amount of constituent (ii) is in the range of from 5:2 to 1:2, based on the total amount of the composition.

6. The composition according to claim 1 additionally comprising one or more further components selected from the group consisting of formulation auxiliaries and formulation additives customary in crop protection.

7. Use of a composition according to claim 1 for the protection of crop plants, preferably of cereal crop plants, in particular of wheat crop plants or barley crop plants.

8. Use according to claim 7 characterized in that said composition is applied post emergence to the cereal crop plants, in particular to wheat crop plants or barley crop plants.

9. Method for controlling undesired vegetation characterized in that a composition as defined in claim 1 is applied to the undesired vegetation or to the area on which the crop plants are growing or will be growing.

10. Method according to claim 9 characterized in that the composition is applied post emergence to the crop plants, preferably post emergence to cereal crop plants.

11. Use according to claim 7 characterized in that said composition is applied such that the amount of ethofumesate is in the range of from 700 g/ha to 50 g/ha.

12. Use according to claim 7 characterized in that said composition is applied to the cereal crop plants post emergence before BBCH growth stage 13, preferably at BBCH growth stages 09, 10, 11 and/or 12, of the cereal crop plants.

13. Use according to claim 7 characterized in that the crop plants are wheat crop plants or barley crop plants.

14. Use according to claim 7 characterized in that the crop plants are selected from the group consisting of Triticum durum, Triticum aestivum and Hordeum vulgare.

15. Use of mefenpyr-diethyl or cloquintocet-mexyl as safener for ethofumesate, preferably in cereal crops, in particular in wheat crop plants or barley crop plants.

16. Method according to claim 10 characterized in that said composition is applied such that the amount of ethofumesate is in the range of from 700 g/ha to 50 g/ha.

17. Method according to claim 10 characterized in that said composition is applied to the cereal crop plants post emergence before BBCH growth stage 13, preferably at BBCH growth stages 09, 10, 11 and/or 12, of the cereal crop plants.

18. Method according to claim 10 characterized in that the crop plants are wheat crop plants or barley crop plants.

19. Method according to claim 10 characterized in that the crop plants are selected from the group consisting of Triticum durum, Triticum aestivum and Hordeum vulgare.
